(19) United States
(12) Patent Application Publication
(10) Pub. No.: US 2016/0246574 A1
(43) Pub. Date: Aug. 25, 2016

(54) TASK SEQUENCER

(71) Applicant: Eddie Jakobitz, Johnstown, CO (US)

(72) Inventor: Eddie Jakobitz, Johnstown, CO (US)

(21) Appl. No.: 14/628,664

(22) Filed: Feb. 23, 2015

(51) Int. Cl. G06F 9/44

(52) U.S. Cl. CPC G06F 8/30

(57) ABSTRACT

A method for modifying a software application. The method includes selecting a first node in a graph. The graph represents logic of a software application. The first node is loaded into a memory. A function associated with the first node is executed by passing to the function one or more parameters associated with the first node. The first node is set to a state returned by the function. A first edge attached to the first node that matches the state returned is selected by the function. The first edge is followed to a second node.

### BACKGROUND

Software applications may be custom-tailored for particular environments, uses, and/or customers. Accordingly, such software may be updated or otherwise modified in response to changes in these factors. However, software applications can be difficult to modify after having been designed and customized for a specific customer or purpose. For example, to change the behavior of a software application, the code of the application is first modified. Once the code has been modified, the application may be rebuilt based on the modified code.

This method for changing the behavior of a software application is both time consuming and expensive. Therefore, it would be beneficial to have an improved system and method for modifying a software application.

### SUMMARY

A method for modifying a software application is disclosed. The method includes selecting a first node in a graph. The graph represents logic of a software application. The first node is loaded into a memory. A function associated with the first node is executed by passing to the function one or more parameters associated with the first node. The first node is set to a state returned by the function. A first edge attached to the first node that matches the state returned is selected by the function. The first edge is followed to a second node.

A non-transitory computer-readable medium is also disclosed. The medium stores instructions that, when executed by at least one processor of a computing system, cause the computing system to perform operations. The operations include selecting a first node in a graph. The graph represents logic of a software application. The first node is loaded into a memory. A function associated with the first node is executed by passing to the function one or more parameters associated with the first node. The first node is set to a state returned by the function. A first edge attached to the first node that matches the state returned is selected by the function. The first edge is followed to a second node.

A computing system is also disclosed. The computer system includes one or more processors and a memory system. The memory system includes one or more non-transitory, computer-readable media including instructions that, when executed by at least one of the one or more processors, cause the computing system to perform operations. The operations include selecting a first node in a graph. The graph represents logic of a software application. The first node is loaded into a memory. A function associated with the first node is executed by passing to the function one or more parameters associated with the first node. The first node is set to a state returned by the function. A first edge attached to the first node that matches the state returned is selected by the function. The first edge is followed to a second node.

### BRIEF DESCRIPTION OF THE DRAWINGS

The accompanying drawings, which are incorporated in and constitutes a part of this specification, illustrates an embodiment of the present teachings and together with the description, serves to explain the principles of the present teachings. In the figures:

FIG. 1 illustrates a graph including nodes and edges, according to an embodiment.

FIG. 2 illustrates a flow chart of a method for navigating the graph shown in FIG. 1, according to an embodiment.

FIG. 3 illustrates a flow chart of a method for creating sequences with a sequence designer and then executing the sequences in a client application, according to an embodiment.

FIG. 4 is a diagram illustrating how to construct a logical operation “AND” between conditions A, B, and C, according to an embodiment.

FIG. 5 illustrates a flow chart that can be used to create a sequence for a task sequencer, according to an embodiment.

FIG. 6 illustrates a schematic view of a computing or processor system for performing the method, according to an embodiment.

FIG. 7 illustrates a flow chart describing the logic for testing a single stand-alone motor, according to an embodiment.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawings that form a part of the description, and in which is shown by way of illustration one or more specific example embodiments in which the present teachings may be practiced.

Further, notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

The task sequencer described herein allows a software application to be customized and changed over time without requiring the application or code to be rebuilt. That is, the application's behavior and logic can be changed simply by editing the sequence that controls it, or by loading a new sequence file. The code (e.g., binary code) does not need to be changed or rebuilt. Not only does the code not need to be rebuilt, but during a single run of the code, the application can load and unload several sequences so that it can execute many different logical sequences in one run. This means that not only does the code not need to be rebuilt to change its logic, but it doesn't even need to be restarted, and it can change its logic any number of times during a single run. This may differ from programs such as LABVIEW® where the binary code needs to be rebuilt whenever the logic is changed.

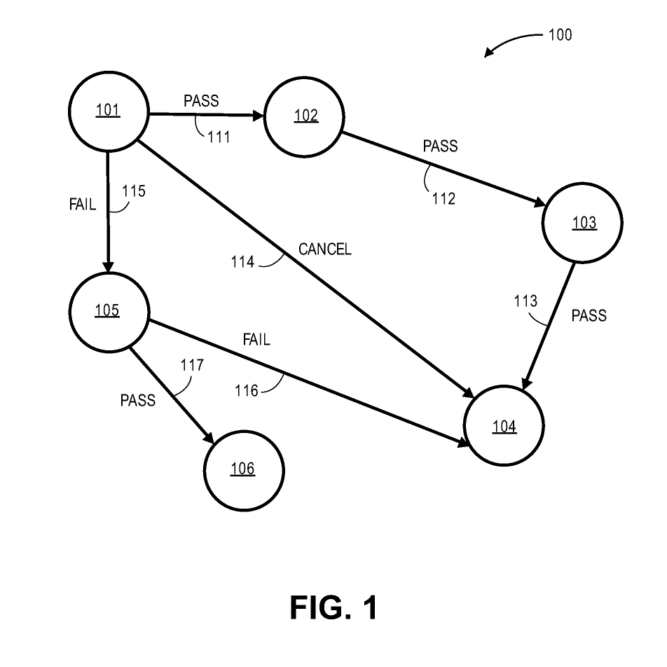

To use the task sequencer, an application links to a task sequencer library, and a sequence is created that defines the desired behavior of the application. The task sequencer library is a native library with no dependencies. An application that uses the task sequencer library need only include the task sequencer dll. As used herein, a “sequence” refers to a stored version of a graph similar to the one shown in FIG. 1. The graph contains the nodes and edges as well as the functions to be called, the parameters to those functions, and the states of the nodes and edges. The graph also defines the possible paths between the functions to be executed and thereby defines the desired logic. Then, once the application starts, the application invokes the task sequencer instructing it as to which sequence to load and where to start in that sequence. The task sequencer then takes over control of the application and walks through the logic described in the sequence.

Creating a sequence can be done using a flow charting program. A flow chart can be created that describes the desired logic. This flow chart can then be processed by the sequence designer which creates a sequence that contains the logic described in the flow chart and is in a format that the task sequencer understands. This results in visual programming, as the logic is created visually in the flow charting program, which is processed by the sequence designer, loaded by the task sequencer library, and executed in the application.

In addition to making development a visual process, this process can also move development out of the domain of a software engineer. Since the logic can be designed by way of a flow chart rather than code, an applications engineer or support technician can respond to customer requests for application changes by updating the flow chart and sending the new sequence to the customer. Depending upon the extent of the changes, it is possible to have a turn-around time as short as a few hours.

The sequence referred to above is implemented internally by the task sequencer as a graph. In computer science, a graph is a structure that includes nodes and edges. Nodes exist as vertices in the graph, and the edges connect them together. Both nodes and edges can contain data. In the case of the graph implemented by the task sequencer, the nodes contain a function to be executed, data or parameters to be passed to the function, and state information. The function can be, for example, PromptUser( ). The data or parameters can be, for example, in the case of the function PromptUser( ), some text to be displayed to the user such as “Select OK to continue.” The edges contain only state information. The state information can be, for example, one of the defined states such as PASS or FAIL. The function may be any function that the application has defined. The task sequencer is able to call any function that is made available to it through the application. Also, the parameters may be anything as well. Any data or parameters that a given function needs may be stored in a node. The states assigned to an edge or node may only be one of the defined values such as PASS, FAIL, CANCEL, etc. The current implementation defines a few states but other implementations may define many others.

FIG. 1 illustrates a graph 100 including nodes 101-106 and edges 111-117, according to an embodiment. In some embodiments, a graph can contain hundreds or even thousands of nodes and edges describing very complex logic.

As shown in the simplistic example of FIG. 1, there are six nodes 101-106 and seven edges 111-117. In this embodiment, the edges 111-117 are unidirectional. As such, the sequencer can follow an edge (e.g., edge 111) from the start to the end but not in the reverse direction. In other embodiments, one or more of the edges 111-117 may be bidirectional. The task sequencer performs the logic described in the sequence by traversing the internally implemented graph 100. The algorithm to traverse the graph 100 in FIG. 1 is quite simple. However, as will be appreciated, there is no limit to the complexity of the logic that can be described by the graph 100 and thus implemented by the sequencer given an increasingly complex graph including a greater number of nodes and edges.

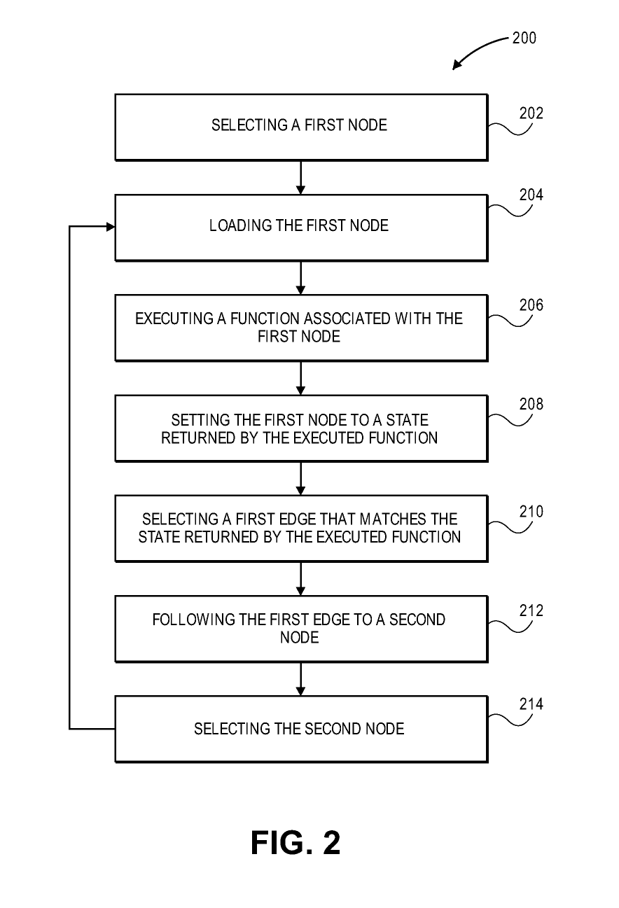

FIG. 2 illustrates a flow chart of a method 200 for navigating the graph 100 shown in FIG. 1, according to an embodiment. As such, FIG. 2 may be viewed together with FIG. 1. The method 200 begins by selecting a first node 101 in a graph, as shown at 202 in FIG. 2. The graph 100 may represent a software application's logic. The selected (e.g., first) node 101 may then be loaded into a memory, as at 204 in FIG. 2. A function associated with the first node 101 may then be executed by passing the function one or more parameters associated with the first node 101, as at 206 in FIG. 2. As used herein, “associated with” refers to being stored within or being contained by. For example, a node contains a function, and that function's parameters within itself. Data associated with the first node 101 may also be passed to the function.

The first node 101 may be set to the state returned by the executed function, as at 208 in FIG. 2. A first edge 111 that is attached to the first node 101 and that matches the state returned by the function may be selected, as at 210 in FIG. 2. The first edge 111 may be an outgoing edge that extends away from the first node 101 in one direction. The first edge 111 may be followed to a next (e.g., second) node 102 at the end of the first edge 111, as at 212 in FIG. 2. The second node 102 may then be selected, as at 214 in FIG. 2. The method 200 may then loop back to step 204 with the second node 102 being loaded.

The task sequencer continues to execute the method 200 until there is no longer a path or edge to follow. This occurs when the current node (e.g., node 106) has no outgoing edges, or none of the outgoing edges match the state returned by the executed function. The steps above describe the graph traversal algorithm at a high level.

Block 206 above specifies that the function associated with the selected node (e.g., node 101) is to be executed. This function can originate from the application itself, a library linked into the application, or it can be internal to the task sequencer library. To create a task, which is internally represented as a node (e.g., node 101), the application or the sequence designer calls the task sequencer's API call AddTask( ). The AddTask( ) prototype is defined as follows: int AddTask(TaskFunction task, void* taskParms, char* name)

The first parameter “task” is the function to be associated with the task being created. This can be a function from the application, a function from a library linked into the application, or a function internal to the task sequencer library. The function matches the parameters and the return type of “TaskFunction” which is defined as: State (*TaskFunction)(void**)

That is, it is a function that takes the address of a buffer pointer and returns a state. Any function that matches this definition can be used as a task function. If one of the functions internal to the task sequencer is desired, then one of the following three values can be specified in the “task” parameter:

(1) TSEQ_TASK_PROMPT_USER

This value displays a message and prompts the user for a response.

(2) TSEQ_TASK_DISPLAY_INFORMATION

This value displays information including an image and prompts the user.

(3) TSEQ_TASK_MAKE_CHOICE

This value makes a decision based on the state of another node

In addition to the internal functions, any function that matches the definition of TaskFunction can be called, which means that there is no limit to what any given task can perform.

The second parameter “taskParms” is the address of a buffer which is passed to the task's function. This buffer can contain anything. Any data that the task function might need can be passed in this buffer. The task sequencer does not analyze or care about the contents of this buffer. It simply holds the buffer and passes it to the function when the function is called. The task function that is assigned is responsible for knowing what to do with the contents of this buffer.

The third parameter “name” is a name that is associated with the task. This name is used by clients of the task sequencer library as a way to reference this task at a later time. This might be for obtaining the state of a task or linking the task to another task.

As stated above, the task sequencer API call AddTask( ), as well as the other API calls, can be called from either the client application or the sequence designer. In practice, most of the API calls are called by the sequence designer to create and edit a sequence. The client application generally calls just a few of the API's in order to execute the sequence. This is common because it is usually the sequence designer that creates and edits the sequences. The client application then loads and executes the sequences created by the sequence designer and, thus, the client application makes fewer API calls into the task sequencer library. Although this is the general convention, both the client application and the sequence designer can make any of the task sequencer API calls.

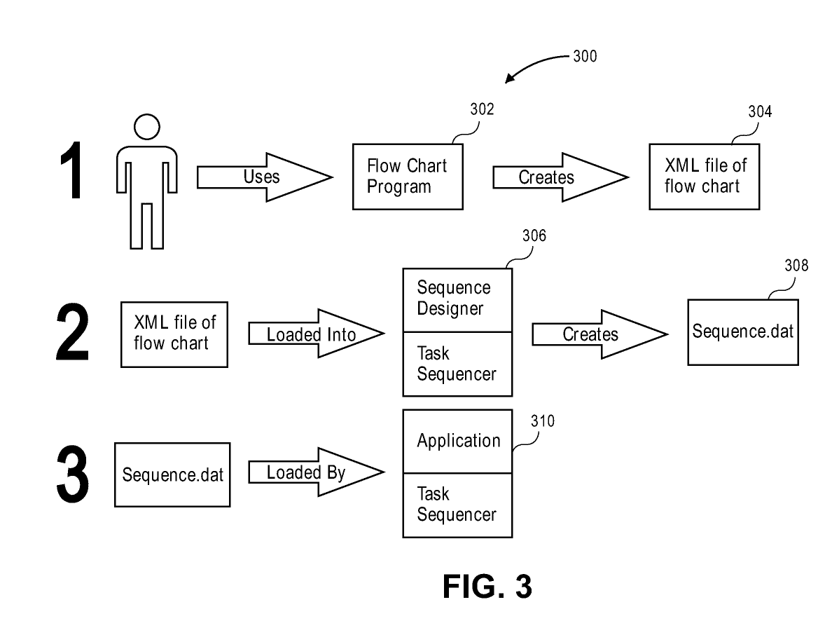

FIG. 3 illustrates a flow chart of a method 300 for creating sequences with the sequence designer and then executing the sequences in the client application, according to an embodiment. First, a user creates a flow chart (e.g., flow chart 200) describing the desired logic using a flow charting program, as at 302. The flow charting program then saves the flow chart to a file, such as an extensible markup language (XML) file, as at 304.

Second, the XML file is loaded into the sequence designer, as at 306. The sequence designer parses the XML and creates a second file, which may be a sequence.dat file, as at 308. The sequence designer does this by linking to the task sequencer library and calling task sequencer API calls such as AddTask( ), ConnectTasks( ), and SaveSequence( ).

Third, the application loads the sequence.dat file and executes the logic originally described in the flow chart, as at 310. The application does this by linking to the task sequencer library and calling task sequencer API calls LoadSequence( ) and ExecuteTasks( ).

The task sequencer library is linked into both the sequence designer and the client application. This is because all functionality related to the creation, editing, and execution of a sequence is done in the task sequencer library. The sequence designer performs the functionality of parsing the XML file itself but calls into the task sequencer library for the creation, editing, and saving of the sequence. The application performs the functionality of initializing itself, creating the user interface (“UI”), and providing many of the task functions but calls into the task sequencer library to load and execute the sequence. Once the application calls into the task sequencer library to execute the sequence, it relinquishes control to the task sequencer library which then controls the application by executing the predefined logic and calling the task functions.

As described above, the internal choice function can be specified by setting the task parameter of AddTask( ) to TSEQ_TASK_MAKE_CHOICE. This task function does not output anything. Its function is to make a choice based upon the state of another node in the graph 200. That is, this task will return as its state, either pass or fail depending on whether or not the state of the node to which it is to look at matches the criterion specified. The task sequencer can then branch down the pass path or the fail path and traverse different paths through the graph 200 executing different functions based upon the decision made by the choice function. Although a single node executing a single choice function can make only one decision, several nodes with choice functions can be chained together to implement various logical operations such as AND, OR, NOT, and other known Boolean logic operations.

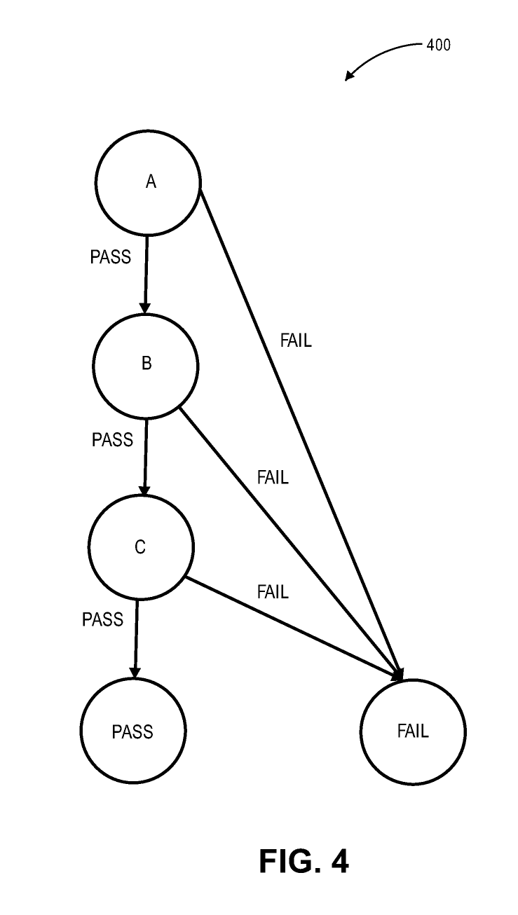

FIG. 4 is a diagram illustrating how to construct a logic operation “AND” between conditions A, B, and C, according to an embodiment. Looking at the path taken when different pass/fail conditions exist, it can be seen how this implements the logic operation AND. By simply swapping the pass and fail paths, this can be changed into the logic operation “OR” of A, B, and C. Other logical operations can also be created using the choice task. Ultimately, any logic operation can be constructed in this manner. The graph resulting from creating logic such as this is similar to a finite automaton with the automaton's alphabet being made up of all the possible state values of the graph. As with any finite automaton, and the graph implemented here, very complex logic can be implemented including condition checking, looping, etc.

The criterion used by the choice task is as follows.

1. The task whose state is to be checked
2. The conditional operator (equal or not equal)
3. The state value to compare to (pass, fail, cancel, exception, or not run) The result is a logical statement for the choice task that results in that node being set to pass or fail and the sequencer then following the associated pass or fail path. Such a statement might look like this:
Task7=pass
When the selected node is encountered in the graph, the state of Task7 will be compared to pass, and the state of the current node is set to either pass or fail depending upon whether or not Task7's state equals pass. As described earlier, a flow charting program can be used to describe the logic and create the sequences.

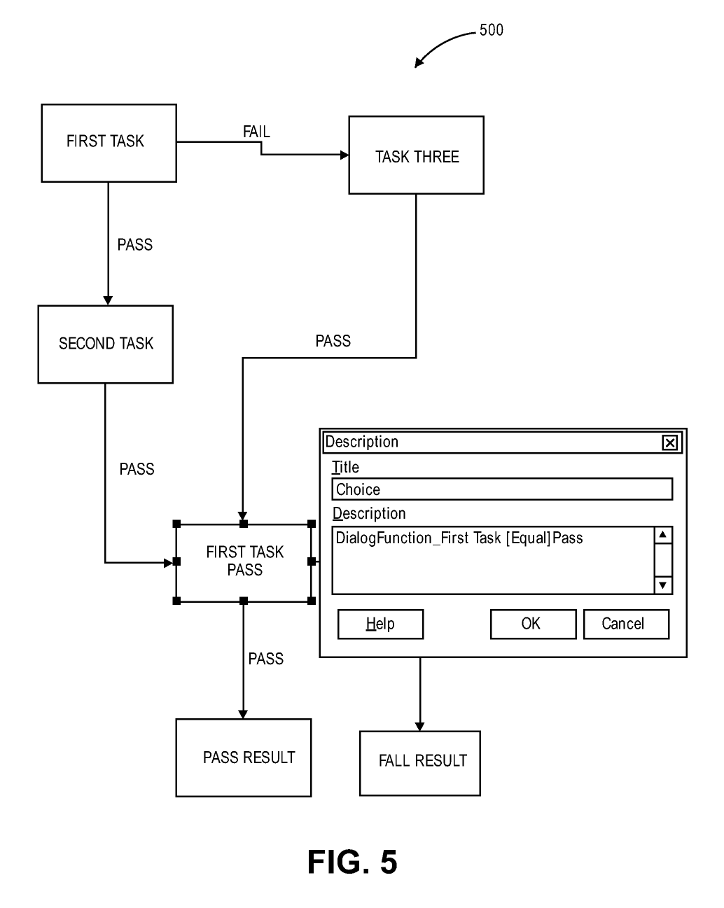

FIG. 5 illustrates a flow chart 500 that can be used to create a sequence for the task sequencer, according to an embodiment. In the flow chart, each shape corresponds to a task or node in a resulting graph. The description dialog that appears next to the “First Task Pass” shape displays the function to be executed at this node and the parameters to that function. In this case, it is a choice function. As a result, “Choice_” appears in the title field, and the parameters to the choice function appear in the description field. This particular choice node is checking if the first task is equal to pass. In order to use a pre-existing flow charting program and not need to write a custom one, the available fields are used for their own purposes. This results in the task function being specified in the title field and the function parameters being specified in the description field. Finally, the lines connecting the shapes correspond to the connections between the tasks or the edges within the graph.

This flow chart can be saved by the flow charting program to an XML file. The XML file is then read in by the sequence designer, which parses the XML looking for the shapes, lines, and their attributes and creates a sequence that the task sequencer can then load and use to control the client application. Again this results in visual programming which allows for an application to be easily modified without any programming effort.

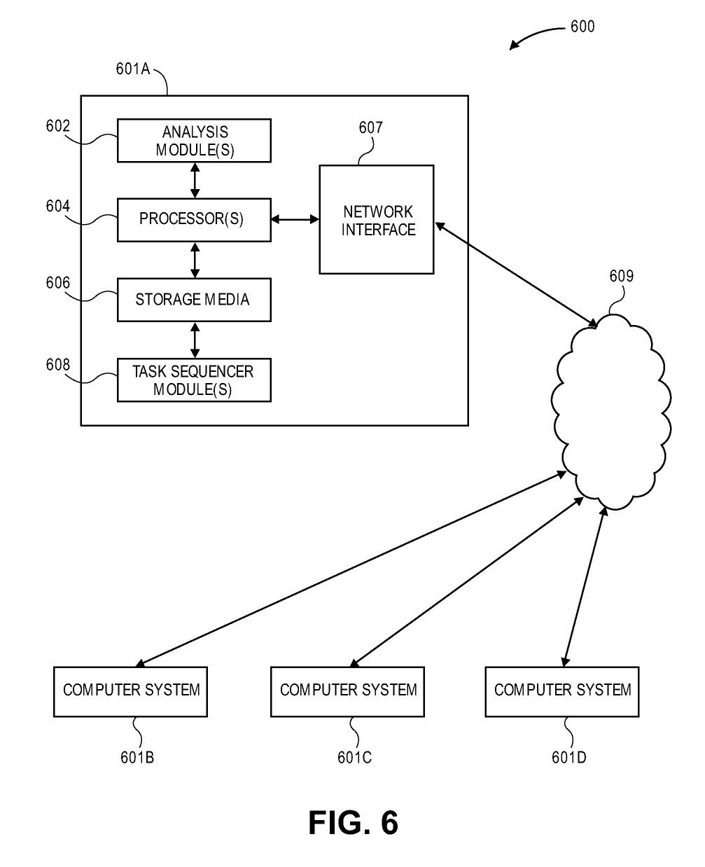

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor can include a microprocessor, microcontroller, processor module or subsystem, programmable integrated circuit, programmable gate array, or another control or computing device.

The storage media 606 can be implemented as one or more computer-readable or machine-readable storage media. Note that while in some example embodiments of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 600 contains one or more task sequencer module(s) 608. In the example of computing system 600, computer system 601A includes the task sequencer module 608. The task sequencer module 608 may be or include software that links to an application. In some embodiments, a single task sequencer module may be used to perform some or all aspects of one or more embodiments of the methods disclosed herein. In alternate embodiments, a plurality of task sequencer modules may be used to perform some or all aspects of methods disclosed herein.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

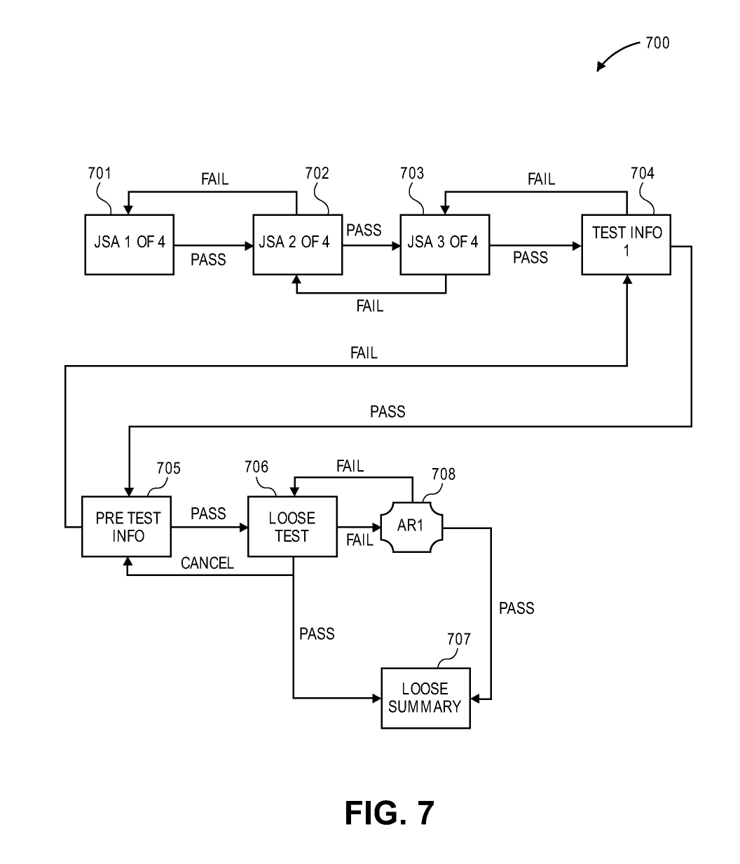

FIG. 7 illustrates a flow chart 700 describing the logic for testing a single stand-alone motor, according to an embodiment. The creation of the flow chart 700 is the first step in a series of steps that go from designing a flow chart to an application executing its logic. The first step may be creating this flow chart 700 with a flow charting application and saving it as, for example, an XML file. Next, the XML file may be loaded into the sequence designer which may parse the XML file and call into the task sequencer library to generate a binary version of the sequence and create a sequence.dat file. The application may then call into the task sequencer library, which may load the sequence.dat file and execute the logic initially defined in the flow chart 700.

More particularly, the first five rectangles 701-705 represent informational screens. They are tasks that display information to the user. As such, the function assigned to these first five tasks 701-705 simply displays a dialog with an image and one or more buttons. The parameters that are passed to this function define what image will be displayed and what buttons will appear. In the case of these first five tasks 701-705, the same function may be assigned to all but, since each task has its own set of parameters, each task displays different buttons and images. The purpose of these tasks 701-705 may be to allow the user to read some safety and procedural information. The user then has the option to acknowledge the information or go back to the prior screen and re-read that information. That is why there exists both pass and fail arrows coming out of these tasks 701-705. The acknowledge button causes the function to return PASS and the back button causes the function to return FAIL. These assignments are configured in the task's parameters. Looking at the flow chart 700, it may be seen how PASS and FAIL results may cause the task sequencer to move between the tasks 701-705.

For example, the first task 701 (JSA stands for “job safety analysis”) may inform the user that the motor to be tested may apply a voltage up to 10 k volts. If the user acknowledges this information, the user may select pass and advance to the second task 702. The second task 702 may inform the user how to discharge any residual voltage, how to ground the motor, etc. If the user acknowledges this information, the user may select pass and advance to the third task 703. The third task 703 may set a status of the motor as “under testing procedures” so that all others that may want to use the motor are aware of the status. If the user acknowledges this information, the user may select pass and advance to the fourth task 704. The fourth and fifth tasks 704, 705 may inform the user about the tests that will be performed.

The “Loose Test” task 706 has been assigned a function to perform a test on the motor. The test may be testing for various currents, voltages, faults, etc. The function has been defined by the application and may be capable of performing an electrical test. Once the test has been performed, the function returns either PASS, FAIL, or CANCEL. This may be the result of the actual test passing, failing, or the user canceling the test. If the function returns CANCEL, then the sequencer goes back to the prior task (e.g., task 705) and re-displays the pre-test information dialog as defined by the prior task. If the test passes and the function returns PASS, then the sequencer goes to the “Loose Summary” task 707 whose function displays a summary screen with information on the results of the test. If the test fails and the function returns FAIL, then the sequencer goes to the “AR1” task 708. This task calls a function that displays a very simple dialog to the user prompting him to either accept the current results (AR stands for accept results) or retry the test.

If the user chooses to retry the test, then the function returns FAIL, and the sequencer goes back to the “Loose Test” task 706. If the user chooses to accept the current results, then the function returns PASS, and the sequencer goes to the “Loose Summary” task 707, which then displays the results. The “Loose Summary” task 707 is assigned a function which displays a more complex dialog showing the results of the test. The term “Loose” in this context refers to the fact that this is a loose motor as opposed to a motor attached to a system. The “Loose” term has nothing to do with the task sequencer but is mentioned only to add clarification to its use in the flow chart 700.

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for modifying a software application, comprising:
selecting a first node in a graph, wherein the graph represents logic of a software application;
loading the first node into a memory;
executing a function associated with the first node by passing to the function one or more parameters associated with the first node;
setting the first node to a state returned by the function;
selecting a first edge attached to the first node that matches the state returned by the function; and
following the first edge to a second node.

2. The method of claim 1, wherein the function originates from the software application, the function originates from a library linked into the software application, or the function is internal to a task sequencer library.

3. The method of claim 1, wherein the software application comprises a code, and wherein the logic of the software application is modified without modifying or rebuilding the code.

4. The method of claim 3, wherein the code comprises a binary code.

5. The method of claim 4, wherein modifying the logic comprises editing a sequence that controls the logic, and wherein a task sequencer instructs the software application to load the sequence and where to start in the sequence.

6. The method of claim 5, wherein the logic is processed by a sequence designer, loaded by a library of the task sequencer, and executed in the software application.

7. The method of claim 5, wherein the sequence is implemented internally by the task sequencer as the graph.

8. A non-transitory computer-readable medium storing instructions that, when executed by at least one processor of a computing system, cause the computing system to perform operations, the operations comprising:
selecting a first node in a graph, wherein the graph represents logic of a software application;
loading the first node into a memory;
executing a function associated with the first node by passing to the function one or more parameters associated with the first node;
setting the first node to a state returned by the function;
selecting a first edge attached to the first node that matches the state returned by the function; and
following the first edge to a second node.

9. The non-transitory computer-readable medium of claim 8, wherein the function originates from the software application, the function originates from a library linked into the software application, or the function is internal to a task sequencer library.

10. The non-transitory computer-readable medium of claim 8, wherein the software application comprises a code, and wherein the logic of the software application is modified without modifying or rebuilding the code.

11. The non-transitory computer-readable medium of claim 10, wherein modifying the logic comprises editing a sequence that controls the logic.

12. The non-transitory computer-readable medium of claim 11, wherein a task sequencer instructs the software application to load the sequence and where to start in the sequence.

13. The non-transitory computer-readable medium of claim 12, wherein the logic is processed by a sequence designer, loaded by a library of the task sequencer, and executed in the software application.

14. The non-transitory computer-readable medium of claim 12, wherein the sequence is implemented internally by the task sequencer as the graph.

15. A computing system, comprising:
one or more processors; and
a memory system comprising one or more non-transitory, computer-readable media comprising instructions that, when executed by at least one of the one or more processors, cause the computing system to perform operations, the operations comprising:
selecting a first node in a graph, wherein the graph represents logic of a software application;
loading the first node into a memory;
executing a function associated with the first node by passing to the function one or more parameters associated with the first node;
setting the first node to a state returned by the function;
selecting a first edge attached to the first node that matches the state returned by the function; and
following the first edge to a second node.

16. The computing system of claim 15, wherein the function originates from the software application, the function originates from a library linked into the software application, or the function is internal to a task sequencer library.

17. The computing system of claim 15, wherein the software application comprises a code, and wherein the logic of the software application is modified without modifying or rebuilding the code.

18. The computing system of claim 17, wherein modifying the logic comprises editing a sequence that controls the logic.

19. The computing system of claim 18, wherein a task sequencer instructs the software application to load the sequence and where to start in the sequence.

20. The computing system of claim 19, wherein the logic is processed by a sequence designer, loaded by a library of the task sequencer, and executed in the software application.
